(19) United States
(12) Patent Application Publication
(10) Pub. No.: US 2019/0003574 A1
(43) Pub. Date: Jan. 3, 2019

(54) SWITCH MODULE

(71) Applicant: GM GLOBAL TECHNOLOGY OPERATIONS LLC, Detroit, MI (US)

(72) Inventor: Hermann Kayser, Kleinwallstadt (DE)

(73) Assignee: GM GLOBAL TECHNOLOGY OPERATIONS LLC, Detroit, MI (US)

(21) Appl. No.: 16/021,992

(22) Filed: Jun. 28, 2018

(30) Foreign Application Priority Data
Jun. 29, 2017 (DE) 102017006151.3

(51) Int. Cl. F16H 59/10; F16H 59/04; F16H 59/02

(52) U.S. Cl. CPC F16H 59/10; F16H 2059/026; F16H 59/0278; F16H 59/042

(57) ABSTRACT

The present disclosure relates to a switch module for a gearbox, in particular a motor vehicle gearbox, with a housing, a switching shaft and a control lever for moving the switching shaft relative to the housing. The housing has an interface for temporarily fastening an assembly device. The control lever has an interface for interacting with the assembly device fastened to the housing interface for limiting its actuating path.

### CROSS-REFERENCE TO RELATED APPLICATION

This application claims priority to German Patent Application No. 10 2017 006 151.3, filed Jun. 29, 2017, which is incorporated herein by reference in its entirety.

### TECHNICAL FIELD

The present disclosure relates to a switch module for a gearbox, a switch module array, a gearbox array and a motor vehicle, in particular a passenger car, with the switch module, along with a method for assembling the switch module.

### BACKGROUND

It is generally known to temporarily fasten so-called stop pins to the housings for adjusting switch modules of gearboxes in motor vehicles, so that they positively interact with switching shafts, and thereby limit their movements, so as to adjust the switch modules.

### SUMMARY

One embodiment of the present disclosure has a switch module for a gearbox, in particular a motor vehicle gearbox, in particular a switch module of a switch module- or gearbox array, in particular of a motor vehicle, in particular a passenger car, a housing, a switching shaft and a control lever for moving the switching shaft relative to the housing.

In an embodiment, the housing is fastened to the gearbox or set up for this purpose. In an embodiment, the control lever is alternatively or additionally hinged, in particular rotatably, to the housing and/or hinged, in particular rotatably, to the switching shaft. In an embodiment, the switching shaft is displaced by the control lever or its movement relative to the housing (translationally, in particular in its axial direction), in particular for selecting one of several gears, in particular shifting gates, or the switch module, in particular the control lever, is set up for this purpose. Accordingly, the control lever in one embodiment is a so-called selector.

In an embodiment, the gearbox can resultantly be advantageously shifted, in particular various gears, in particular shifting gates, can be selected.

In an embodiment of the present disclosure, an assembly device of the switch module array is temporarily, in particular non-destructively, detachably fastened to an interface of the housing, which accordingly is here also referred to as the housing interface, and interacts, in particular in a contacting manner, with an interface of or on the control lever, which accordingly is here also referred to as the control lever interface, so as to limit an adjustment/actuating, in particular swivel, path of the control lever or so that an adjustment/actuating, in particular swivel, path of the control lever is limited by the assembly device that is temporarily, in particular non-destructively, detachably fastened to the housing interface and interacts with the control lever interface, in particular contacting it, or the switch module, in particular its housing interface and/or its control lever interface, and/or the assembly device is set up or used for this purpose. Accordingly, the housing in one embodiment has the housing interface for temporarily fastening the assembly device, and the control lever has the control lever interface for interacting with the assembly device fastened to the housing interface for limiting its actuating path.

In an embodiment, this makes it possible to improve, in particular simplify, assembly and/or improve its reliability and/or precision, and/or, when setting the switch module, in particular its control lever, reduce the play, in particular the influence of play between the control lever (movement) and switching shaft (movement), in particular eliminate it, and thereby improve an operation, in particular the switching precision, of the switch module.

In an embodiment, the switching shaft, in addition to a degree of freedom actuatable by the control lever, in particular a displaceability or translational degree of freedom relative to the housing, has at least one additional degree of freedom, in particular a rotational degree of freedom relative to the housing, in particular for engaging and disengaging (selected) gears of the gearbox.

In an embodiment, this makes it possible to advantageously shift, in particular engage and disengage different gears.

In a further development, the assembly device that is temporarily, in particular non-destructively, detachably fastened to the housing interface and limits the actuating path of the control lever interacts, in particular in a contacting manner, with an interface of or on the switching shaft, which accordingly is here also referred to as a switching shaft interface, so as to limit a movement, in particular an adjustment/actuation, of the switching shaft or so that a movement, in particular an adjustment/actuation, of the switching shaft is limited by the assembly device that is temporarily, in particular non-destructively, detachably fastened to the housing interface and interacts with the control lever interface and the switching shaft interface, in particular contacting them, or the switch module, in particular its housing, control lever and switching shaft interface, and/or the assembly device is set up or used for this purpose.

In an embodiment, the switching shaft correspondingly has the switching shaft interface for interacting with the assembly device fastened to the housing interface for limiting a movement by the switching shaft in the additional degree of freedom. When fastened to the housing interface, the assembly device limits the actuating path of the control lever by interacting with the control lever interface primarily or (in any case) before (indirectly) limiting the actuating path by limiting a corresponding movement of the switching shaft (in the degree of freedom actuated by the control lever) with an interaction between the assembly device fastened to the housing interface and the switching shaft interface. The switch module, in particular its control lever interface and its switching shaft interface, and/or the assembly device is set up for this purpose, for example by a corresponding play between the switching shaft interface and the assembly device. In an embodiment, the assembly device fastened to the housing interface limits the actuating path of the control lever by interacting with its control lever interface alone, or the assembly device fastened to the housing interface does not limit the actuating path of the control lever by interacting with the switching shaft interface, or the switch module, in particular its control lever interface and its switching shaft interface, and/or the assembly device is set up for this purpose. In an embodiment, the assembly device fastened to the housing or its housing interface limits the actuating path of the control lever by interacting with its control lever interface also or even if the control lever is/would be decoupled from the switching shaft, or the switch module, in particular its control lever interface, and/or the assembly device is set up for this purpose.

In an embodiment, assembly can hereby be further improved, in particular further simplified and/or its reliability and/or precision can be further increased, and/or adjusting the play of the switch module and thus its operation, in particular its switching precision, can be further improved.

In an embodiment, the movement of the switching shaft is positively and/or frictionally limited uni-directionally or bi-directionally in the additional degree of freedom by the switching shaft interface and the assembly device fastened to the housing interface that interacts with it, in particular in a contacting manner, or the switch module, in particular its housing interface and/or its switching shaft interface, and/or he assembly device is set up or used for this purpose. Accordingly, the assembly device in one embodiment interacts positively and/or frictionally with the switching shaft interface or is set up or used for this purpose.

In an embodiment, the actuating path of the control lever is additionally or alternatively positively and/or frictionally limited uni-directionally or bi-directionally by the control lever interface and the assembly device fastened to the housing interface that interacts with it, in particular in a contacting manner, or the switch module, in particular its housing interface and/or its control lever interface, and/or he assembly device is set up or used for this purpose. Accordingly, the assembly device in one embodiment interacts positively and/or frictionally with the control lever interface or is set up or used for this purpose.

In an embodiment, the assembly and/or disassembly of the assembly device can be improved by a unidirectional movement or a limitation in only one adjustment/actuation direction. In an embodiment, the setting of the switch module can be improved by a bidirectional limitation or a limitation in both opposing adjustment/actuation directions. In an embodiment, a bidirectional limitation limits a movement or an actuating path with (macroscopic) play, in particular of at least one millimeter. In an embodiment, this makes it possible to improve the assembly and/or disassembly of the assembly device. In an embodiment, a bidirectional limitation limits a movement or an actuating path without (macroscopic) play, in particular with a play of at most half a millimeter. In an embodiment, this makes it possible to improve the setting of the switch module. In other words, the assembly device in one embodiment fixes the switching shaft in its additional degree of freedom at the switching shaft interface and/or control lever at the control lever interface without play or with (macroscopic) play.

In an embodiment, the assembly device is additionally or alternatively temporarily fastened frictionally and/or positively to the housing interface or used or set up for this purpose.

In an embodiment, this makes it possible to further improve assembly, in particular further simplify it and/or further increase its reliability and/or precision.

In an embodiment, the housing interface has a housing recess, into which the assembly device temporarily engages in one embodiment, in particular is introduced at least partially, in particular inserted in the axial direction of the recess, or the housing interface and/or assembly device is set up or used for this purpose. In particular, this housing recess can be or include the housing interface.

In an embodiment, the control lever interface additionally or alternatively has a control lever recess, into which the assembly device (fastened to the housing) temporarily engages in one embodiment, in particular is introduced at least partially, in particular inserted in the axial direction of the recess, or the control lever interface and/or assembly device are set up or used for this purpose. In particular, this control lever recess can be or include the control lever interface.

In an embodiment, the switching shaft interface additionally or alternatively exhibits a switching shaft recess, into which the assembly device (fastened to the housing) temporarily engages in one embodiment, in particular is introduced at least partially, in particular inserted in the axial direction of the recess, or the switching shaft interface and/or assembly device is set up or used for this purpose. In particular, this switching shaft recess can be or include the switching shaft interface.

In an embodiment, this makes it possible to further improve assembly, in particular further simplify it and/or further increase its reliability and/or precision.

In an embodiment, the housing recess of the housing interface is a recess that is continuously or bilaterally open in its axial direction, in particular a through hole or a slit. In a further development, the assembly device temporarily fastened to the housing interface engages through this continuous housing recess of the housing interface, or is set up for this purpose.

In an embodiment, the control lever recess of the control lever interface additionally or alternatively is a recess that continuously or bilaterally opens in its axial direction, in particular a through hole or a slit. In a further development, the assembly device temporarily fastened to the housing interface engages through this control lever recess of the control lever interface, or is set up for this purpose.

In an embodiment, this makes it possible to improve the fastening or actuating path or movement limitation, in particular its reliability, and thereby further improve assembly.

In an embodiment, the housing recess of the housing interface is a recess that is blocked, in particular closed, on the floor or in the push-through direction, in particular a blind hole or a groove with a groove bottom. In a further development, the assembly device temporarily fastened to the housing interface engages into this housing recess of the housing interface that is blocked on the floor, or is set up for this purpose.

In an embodiment, the control lever recess of the control lever interface additionally or alternatively is a recess that is blocked, in particular closed, on the floor or in the push-through direction, in particular a blind hole or a groove with a groove bottom. In a further development, the assembly device temporarily fastened to the housing interface engages into this control lever recess of the control lever interface that is blocked on the floor, or is set up for this purpose.

In an embodiment, the switching shaft recess of the switching shaft interface additionally or alternatively is a recess that is blocked, in particular closed, on the floor or in the push-through direction, in particular a blind hole or a groove with a groove bottom. In a further development, the assembly device temporarily fastened to the housing interface engages into this switching shaft recess of the switching shaft interface that is blocked on the floor, or is set up for this purpose. In an embodiment, this makes it possible to limit an insertion, and thereby further improve assembly.

In an embodiment, the housing recess of the housing interface has a closed periphery. In an embodiment, the control lever recess of the control lever interface additionally or alternatively has a closed periphery. In an embodiment, the switching shaft recess of the switching shaft interface additionally or alternatively has a closed periphery.

In an embodiment, a closed periphery can prevent the assembly device from inadvertently sliding radially out of the corresponding recess.

In an embodiment, the housing recess of the housing interface has an interrupted, in particular slit, periphery. In an embodiment, the control lever recess of the control lever interface additionally or alternatively has an interrupted, in particular slit, periphery. In an embodiment, the switching shaft recess of the switching shaft interface additionally or alternatively has an interrupted, in particular slit, periphery.

In an embodiment, an interrupted, in particular slit, periphery further improves the assembly/disassembly of the assembly device. A further development makes it possible to radially introduce the latter into and/or remove it from the corresponding recess.

In an embodiment, the assembly device has an integral design. In an embodiment, it additionally or alternatively has an in particular cylindrical shaft, which interacts with the control lever interface and/or the switching shaft interface, in particular the control lever recess of the control lever interface and/or the switching shaft recess of the switching shaft interface, in particular is introduced into the latter, or is set up or used for this purpose. In an embodiment, the assembly device additionally or alternatively has a ledge, which to create a temporary attachment interacts with the housing interface, in particular the housing recess of the housing interface, in particular is introduced into the latter, or is set up or used for this purpose. In an embodiment, the assembly device additionally or alternatively has an in particular angled, in particular bent, handgrip.

In an embodiment, this makes it possible to further improve assembly, in particular further simplify it and/or further increase its reliability and/or precision, in particular to further improve the fastening or actuating path or movement limitation, in particular further increase its reliability.

In an embodiment of the present disclosure, a method for assembling a switch module described herein, in particular a switch module or gearbox array includes: (temporarily, in particular non-destructively detachably) fastening the assembly device to the housing interface to limit the actuating path of the control lever and, in a further development, the movement of the switching shaft in the additional degree of freedom or in such a way that the assembly device limits the actuating path of the control lever and, in the further development, the movement of the switching shaft in the additional degree of freedom, or for this purpose interacts with the control lever interface and, in the further development, with the switching shaft interface; setting the switch module given or with an actuating path of the control lever limited by the assembly device fastened to the housing interface and, in a further development, given or with a movement of the switching shaft limited by the assembly device fastened to the housing interface in the additional degree of freedom or for this purpose by the control lever interface and, in a further development, by the assembly device interacting with the switching shaft interface; and removing the assembly device from the housing interface and, in an embodiment, in particular in this way, also from the control lever interface and, in the further development, the switching shaft interface.

In an embodiment, setting the switch module involves adjusting an activating device for adjusting the control lever, in particular a wire rope hoist, rod assembly and/or a so-called external switching device with a (hand or gear) lever, and in a further development, adjusting an activating device for moving the switching shaft in the additional degree of freedom, in particular an additional control lever set up for this purpose, in particular a(n additional) wire rope hoist, (additional) rod assembly and/or a or the so-called external switching device with a or the (hand or gear) lever.

### BRIEF DESCRIPTION OF THE DRAWINGS

The present disclosure will hereinafter be described in conjunction with the following drawing figures, wherein like numerals denote like elements.

FIG. 1 a side view of a switch module array with a switch module according to an embodiment of the present disclosure; and

FIG. 2 a side view of the switch module turned by 90°.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

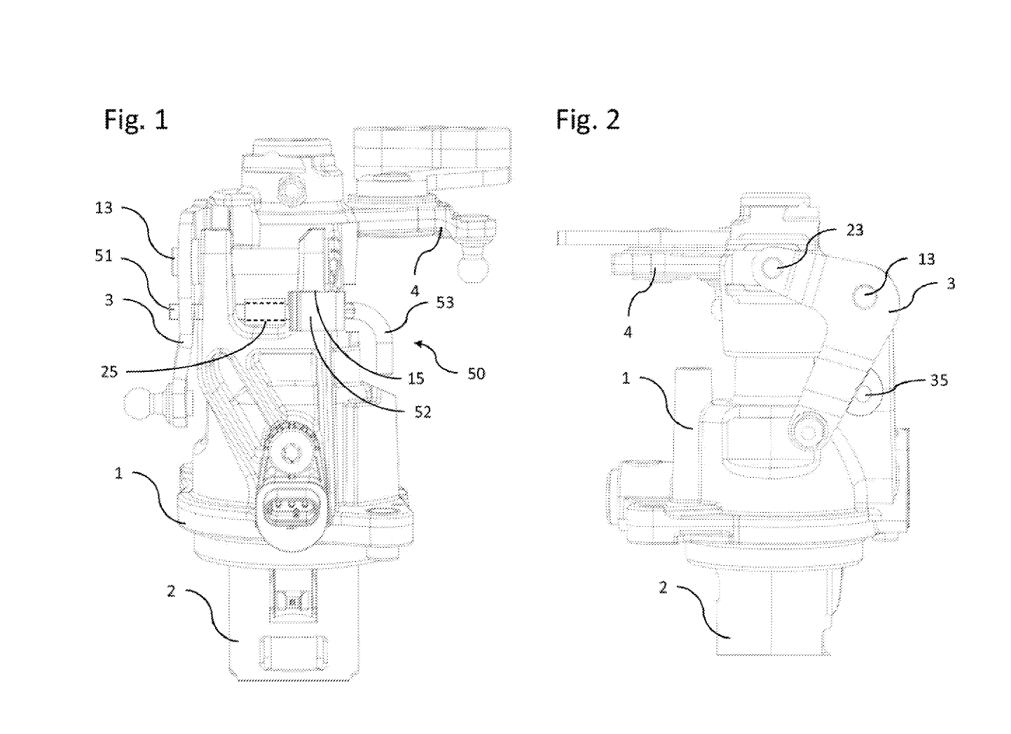

FIGS. 1 and 2 show a switch module according to an embodiment of the present disclosure in two side views turned by 90° relative to each other.

The switch module has a housing 1 and a switching shaft 2, which can be displaced relative to the housing by a selector 3, and rotated by an additional control lever 4, so as—through displacement—to select various gears or shifting gates of a gearbox (not shown) and engage or disengage selected gears—through rotation).

To this end, the selector 3 is rotatably mounted to the housing 1 or switching shaft 2 via two hinges 13, 23, and just as the additional control lever 4, is coupled with a switch lever of an external switching device (no shown) in a known manner by a (respective) Bowden cable, shift linkage or the like.

In order to set the switch module, in particular to adjust this coupling, a shaft 51 of a one-piece assembly device 50 is inserted with a handgrip 53 into a through hole 35 in the selector 3 (see FIG. 2) and a through hole 25 in the switching shaft 2 denoted with a dashed line on FIG. 1, and in so doing a ledge 52 of the assembly device 50 into a recess 15 of the housing 1.

The assembly device 50 that interacts in this way with a control lever interface in the form of the through hole 35 and a switching shaft interface in the form of the through opening 25, and is non-destructively detachably fastened to the housing interface in the form of the recess 15, directly bidirectionally limits a respective actuating path of the selector 3 as well as (at the switching shaft interface or in the through opening 25) a rotation of the switching shaft, so that the switch module can be precisely set, in particular the coupling can be adjusted, for example the corresponding Bowden cable can be tensioned.

The assembly device 50 is then pulled out of the recesses 15, 25, 35 by the handgrip 53, thereby releasing (a displacement of) the selector 3 and (a rotation of) the switching shaft 2.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-12. (canceled)

13. A switch module for a gearbox comprising:
a housing having a housing interface for temporarily fastening an assembly device;
a switching shaft positionable in a first direction with respect to the housing; and
a control lever configured to position the switching shaft in the first direction relative to the housing, the control lever having a control lever interface configured to selectively interact with the assembly device for limiting an actuating path of the control lever.

14. The switch module according to claim 13, wherein the switching shaft is positionable in a second direction with respect to the housing, the switching shaft comprising a switching shaft interface configured to selectively interact with the assembly device for limiting a movement of the switching shaft in the second direction.

15. The switch module according to claim 14, wherein the switching shaft interface is configured to positively limit the movement of the switching shaft in the second direction.

16. The switch module according to claim 14, wherein the switching shaft interface is configured to frictionally limit the movement of the switching shaft in the second direction.

17. The switch module according to claim 13, wherein the control lever interface is configured to positively limit the actuating path of the control lever.

18. The switch module according to claim 13, wherein the control lever interface is configured to frictionally limit the actuating path of the control lever.

19. The switch module according to claim 13, wherein the housing interface is configured to temporarily positively fasten the assembly device.

20. The switch module according to claim 13, wherein the housing interface is configured to temporarily frictionally fasten the assembly device.

21. The switch module according to claim 13, wherein each of the housing interface, the control lever interface and the switching shaft interface has a recess formed therein with a closed periphery and configured to receive the assembly device.

22. The switch module according to claim 13, wherein the control lever is hinged to at least one of the housing and the switching shaft.

23. A switch module assembly for a gearbox comprising:
a switch module having a housing with a housing interface, a switching shaft positionable in a first direction with respect to the housing, and a control lever configured to position the switching shaft in the first direction relative to the housing, the control lever having a control lever interface; and
an assembly device selectively engaging the housing interface and the control lever interface for limiting an actuating path of the control lever.

24. The switch module assembly according to claim 23, wherein the assembly device comprises a shaft configured to engage with the control lever interface and the housing interface.

25. The switch module assembly according to claim 24, wherein each of the housing interface, the control lever interface and the switching shaft interface has a recess formed therein with a closed periphery configured to receive the shaft of the assembly device.

26. The switch module assembly according to claim 24, wherein the assembly device further comprises a handgrip extending from the shaft.
